(19) United States
(12) Patent Application Publication
(10) Pub. No.: US 2025/0184234 A1
(43) Pub. Date: Jun. 5, 2025

(54) METHODS AND APPARATUSES FOR CONFIGURING TOPOLOGY FOR ARTICIFICAL INTELLIGENCE OR MACHINE LEARNING

(71) Applicant: Huawei Technologies Co., Ltd., Shenzhen (CN)

(72) Inventors: Wen Tong, Ottawa (CA); Hao Tang, Ottawa (CA); Jianglei Ma, Ottawa (CA)

(21) Appl. No.: 19/041,543

(22) Filed: Jan. 30, 2025

Related U.S. Application Data
(63) Continuation of application No. PCT/CN2022/113334, filed on Aug. 18, 2022.

(51) Int. Cl. H04L 41/16; H04L 41/0853; H04L 41/12

(52) U.S. Cl. CPC H04L 41/16; H04L 41/0853; H04L 41/12

(57) ABSTRACT

Aspects of the present disclosure provide methods and apparatuses for configuring a topology for artificial intelligence or machine learning (AI/ML) in a wireless communication network. The topology may be configured centrally by a network device or may be self-organized by the nodes in the topology utilizing announcement and discovery messaging. Nodes in the topology may be configured as a Type 1 node that is configured to collect and aggregate a plurality of AI/ML models for obtaining a first type AI/ML model or as Type 2 node that is configured to obtain a second type AI/ML model with its own training data without an aggregation operation, wherein the configured topology includes a connection between at least one Type 1 node and zero or more Type 2 nodes, and/or a connection between at least two Type 1 nodes.

### CROSS-REFERENCE TO RELATED APPLICATION

This application is a continuation of International Application No. PCT/CN2022/113334, entitled “METHODS AND APPARATUSES FOR CONFIGURING TOPOLOGY FOR ARTIFICIAL INTELLIGENCE OR MACHINE LEARNING”, filed on Aug. 18, 2022, which is hereby incorporated by reference in its entirety.

### TECHNICAL FIELD

The present disclosure relates to wireless communication generally, and, in particular embodiments, to methods and apparatuses for configuring a topology for artificial intelligence or machine learning (AI/ML).

### BACKGROUND

Artificial Intelligence technologies may be applied in communication, including AI-based communication in the physical layer and/or AI-based communication in the medium access control (MAC) layer. For example, in the physical layer, the AI-based communication may aim to optimize component design and/or improve the algorithm performance. For the MAC layer, the AI-based communication may aim to utilize the AI capability for learning, prediction, and/or making a decision to solve a complicated optimization problem with possible better strategy and/or optimal solution, e.g. to optimize the functionality in the MAC layer.

In some implementations, an AI architecture in a wireless communication network may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning.

However, communications in wireless communications systems, including communications associated with AI training at multiple nodes, typically occur over non-ideal channels. For example, non-ideal conditions such as electromagnetic interference, signal degradation, phase delays, fading, and other non-idealities may attenuate and/or distort a communication signal or may otherwise interfere with or degrade the communications capabilities of the system.

Conventional AI training processes generally rely on hybrid automatic repeat request (HARQ) feedback and retransmission processes to try to ensure that data communicated between devices involved in AI training is successfully received. However, the communication overhead and delay associated with such retransmissions can be problematic.

In addition, the processing capabilities and/or availability of training data for AI training processes may vary significantly between different nodes/devices, which means that the capacity of different nodes to productively participate in an AI training process can vary significantly. In practice, such disparities often mean that training delays for AI training processes involving multiple nodes/devices, such as distributed learning or federated learning-based AI training processes, are dominated by the node/device having the largest delay due to communication delays and/or computation delays.

Federated learning, which is also known as collaborative learning, is a machine learning technique that trains an algorithm across multiple decentralized edge devices or servers. Each decentralized edge device or server holds local data samples but may not exchange with other devices or servers. The federated learning technique is opposite to traditional centralized machine learning techniques in that local data samples are not shared in the federated learning technique whereas all local datasets are uploaded to one server in traditional centralized machine learning techniques.

In wireless federated learning-based (FL-based) AI training processes, a network node/device/node initializes a global AI model, samples a group of user devices, and broadcasts the global AI model parameters to the user devices. Each user device then initializes its local AI model using the global AI model parameters, and updates (trains) its local AI model using its own data. Each user device may then report its updated local AI model's parameters to the network device, which then aggregates the updated parameters reported by the user devices and updates the global AI model. The aforementioned procedure is one iteration of a conventional FL-based AI model training procedure. The network device and the participating user devices typically perform multiple iterations until the AI model has converged sufficiently to satisfy one or more training goals/criteria and the AI model is finalized.

However, different user devices participating in an FL-based AI training process may observe different training datasets that may not be representative of the distribution of all of the training data observed by other user devices participating in the FL-based AI training process, i.e., training data may not be independently and identically distributed (non-i.i.d) at devices participating in conventional FL-based AI training processes. Non-i.i.d training data among devices has been shown to reduce the convergence speed and model accuracy in conventional FL-based AI training processes. Therefore, data heterogeneity is a typical problem in conventional FL-based AI training processes.

For these and other reasons, new protocols and signaling mechanisms are desired so that new AI-enabled applications and processes can be implemented while minimizing signaling and communication overhead and delays associated with existing AI training procedures.

### SUMMARY

There are restrictions in conventional federated learning-based (FL-based) AI training processes. For example, as stated above, data heterogeneity is a typical problem in conventional FL-based AI training processes. Also, a server node needs to collect massive amount of training data set (e.g. gradients of client node update) from multiple associated client nodes. Further, the conventional FL-based AI training processes requires server node and associated client nodes to have the same AI/ML model structure. However, since different local nodes may support different AI/ML model structures, data heterogeneity may be a problem in conventional FL-based AI training processes.

Aspects of the present disclosure provide solutions to overcome the aforementioned restrictions, for example specific methods and apparatuses for configuring a topology for artificial intelligence or machine learning (AI/ML).

According to a first broad aspect of the present disclosure, there is provided herein a method for configuring a topology for artificial intelligence or machine learning (AI/ML) in a wireless communication network. The method according to the first broad aspect of the present disclosure may include receiving, from a node, information including a report related to AI/ML capability of the node. The method according to the first broad aspect of the present disclosure may further include configuring the node based on the received information, wherein configuring the node includes configuring a node type of the node, the configured node type being one of a plurality of node types. For example, the plurality of node types could include: Type 1 indicative of a node configured to collect a plurality of AI/ML models and aggregate the collected AI/ML models for obtaining a first type AI/ML model, or Type 2 indicative of a node configured to obtain a second type AI/ML model with a set of training data without aggregation operation. The method according to the first broad aspect of the present disclosure may further include configuring one or more other nodes associated with the configured node based on the configured node type. The configured topology supports AI/ML model transfer over an air interface of the wireless communication network, and includes at least a connection between at least one Type 1 node and zero or more Type 2 nodes and/or a connection between at least two Type 1 nodes.

In some embodiments of the method according to the first broad aspect of the present disclosure, the configured node type indicates that the node is a Type 1 node, and the one or more other nodes include at least one of: one or more Type 2 nodes; a second Type 1node providing a first type AI/ML model of the second Type 1 node to the node; or a third Type 1 nodes receiving a first type AI/ML model of the node.

In some embodiments of the method according to the first broad aspect of the present disclosure, the one or more other nodes includes the one or more Type 2 nodes, and configuring the node includes configuring the node to collect respective second type AI/ML models from the one or more Type 2 nodes.

In some embodiments of the method according to the first broad aspect of the present disclosure, the configured node type indicates that the node is a Type 2 node, and the one or more other nodes include one or more Type 1 nodes connected to the node.

In some embodiments of the method according to the first broad aspect of the present disclosure, the information further includes a request by the node to be configured as a Type 1 node.

In some embodiments of the method according to the first broad aspect of the present disclosure, the node is connected to the one or more other nodes over a sidelink using device-to-device (D2D) communication, through a network device, or through an interface between network devices.

In some embodiments of the method according to the first broad aspect of the present disclosure, the node is a user equipment (UE), relay, base station (BS), transmission and reception point (TRP), edge device, network system, or integrated access backhauled (IAB) node.

According to a second broad aspect of the present disclosure, there is provided herein a method for configuring a topology for artificial intelligence or machine learning (AI/ML) in a wireless communication network. The method according to the second broad aspect of the present disclosure may include establishing an aggregation connection with a second node based on an aggregation acknowledgement message. A configured topology in accordance with the second broad aspect of the present disclosure supports AI/ML model transfer over an air interface of the wireless communication network, and includes a connection between at least one Type 1 node and zero or more Type 2 nodes and/or a connection between at least two Type 1 nodes, wherein a Type 1 node is a node that is configured to collect a plurality of AI/ML models and aggregate the collected AI/ML models for obtaining a first type AI/ML model, and a Type 2 node is a node that is configured to obtain a second type AI/ML model with a set of training data without aggregation operation.

Optionally, before establishing an aggregation connection with the second node, the method further comprises: transmitting by the first node to the second node, a message for aggregation. After transmitting the message for aggregation, the first node may receive an acknowledgement message from the second node.

In addition the establishing step is selectively.

In some embodiments of the method according to the second broad aspect of the present disclosure, the message for aggregation is a discovery message including aggregation information to be used by the second node for discovery of the first node.

In some embodiments of the method according to the second broad aspect of the present disclosure, the aggregation information to be used by the second node includes aggregation capability of the first node.

In some embodiments of the method according to the second broad aspect of the present disclosure, the discovery message includes at least one of a model collection indicator or a reference AI/ML model.

In some embodiments of the method according to the second broad aspect of the present disclosure, the model collection indicator includes one of a distillation indicator, a dilation indicator, or a distillation and dilation indicator.

In some embodiments of the method according to the second broad aspect of the present disclosure, the message for aggregation is an aggregation request message, the aggregation request message including an aggregation request or information related to a second type AI/ML model of the first node.

In some embodiments of the method according to the second broad aspect of the present disclosure, the first node is a Type 2 node and the aggregation request message includes the information related to the second type AI/ML model of the first node.

In some embodiments of the method according to the second broad aspect of the present disclosure, the information related to the second type AI/ML model of the first node includes at least one of: information related to neural network of the second type AI/ML model of the first node; information related to size of the second type AI/ML model of the first node; or information related to complexity of the second type AI/ML model of the first node.

In some embodiments of the method according to the second broad aspect of the present disclosure, the first node is a Type 1 node and the aggregation request message includes the aggregation request.

In some embodiments of the method according to the second broad aspect of the present disclosure, the second node is one of a plurality of other nodes in the wireless communication network, and the first node is capable of connecting only with one node of the plurality of other nodes, wherein the processor-executable instructions further comprise processor-executable instructions that, when executed, cause the processor to transmit, by the first node to at least the one node of the plurality of other nodes, a respective confirmation informing whether connection to the first node is successfully established.

In some embodiments of the method according to the second broad aspect of the present disclosure, the first node is a Type 2 node and the second node is a Type 1 node.

In some embodiments of the method according to the second broad aspect of the present disclosure, the first node is a first Type 1 node and the second node is a second Type 1 node providing a first type AI/ML model of the second node to the first node or receiving a first type AI/ML model of the first node from the first node.

In some embodiments of the method according to the second broad aspect of the present disclosure, the first node is a Type 1 node that is only associated with one or more other Type 1 nodes.

In some embodiments of the method according to the second broad aspect of the present disclosure, wherein transmitting the message for aggregation includes broadcasting, groupcasting or unicasting the message for aggregation at predetermined intervals.

According to a third broad aspect of the present disclosure, there is provided herein a method for configuring a topology for artificial intelligence or machine learning (AI/ML) in a wireless communication network. The method according to the third broad aspect of the present disclosure may include receiving, by a first node from a second node, a message for aggregation. After receiving the message for aggregation, the first node may determine whether to connect with the second node and transmit a response indicative of the determination to the second node. The method according to the third broad aspect of the present disclosure may further include selectively establishing an aggregation connection with the second node based on the determination. A configured topology in accordance with the third broad aspect of the present disclosure supports AI/ML model transfer over an air interface of the wireless communication network, and includes a connection between at least one Type 1 node and zero or more Type 2 nodes and/or a connection between at least two Type 1 nodes, wherein a Type 1 node is a node that is configured to collect a plurality of AI/ML models and aggregate the collected AI/ML models for obtaining a first type AI/ML model, and a Type 2 node is a node that is configured to obtain a second type AI/ML model with a set of training data without aggregation operation.

In some embodiments of the method according to the third broad aspect of the present disclosure, the message for aggregation is a discovery message including aggregation information to be used by the first node for discovery of the second node.

In some embodiments of the method according to the third broad aspect of the present disclosure, the aggregation information to be used by the first node includes aggregation capability of the second node.

In some embodiments of the method according to the third broad aspect of the present disclosure, the discovery message includes at least one of a model collection indicator or a reference AI/ML model.

In some embodiments of the method according to the third broad aspect of the present disclosure, the model collection indicator includes one of a distillation indicator, a dilation indicator, or a distillation and dilation indicator.

In some embodiments of the method according to the third broad aspect of the present disclosure, the message for aggregation is an aggregation request message, the aggregation request message including an aggregation request or information related to a second type AI/ML model of the second node.

In some embodiments of the method according to the third broad aspect of the present disclosure, the second node is a Type 2 node and the aggregation request message includes the information related to the second type AI/ML model of the second node.

In some embodiments of the method according to the third broad aspect of the present disclosure, the information related to the second type AI/ML model of the second node includes at least one of: information related to neural network of the second type AI/ML model of the second node; information related to size of the second type AI/ML model of the second node; or information related to complexity of the second type AI/ML model of the second node.

In some embodiments of the method according to the third broad aspect of the present disclosure, the first node determines whether to connect with the second node based on aggregation capability of the first node and the information related to the second type AI/ML model of the second node.

In some embodiments of the method according to the third broad aspect of the present disclosure, the second node is a Type 1 node and the aggregation request message includes the aggregation request.

In some embodiments of the method according to the third broad aspect of the present disclosure, the second node is capable of connecting with only one node, wherein the processor-executable instructions further comprise processor-executable instructions that, when executed, cause the processor to receive, from the second node, a confirmation informing whether connection between the second node and the first node is successfully established.

In some embodiments of the method according to the third broad aspect of the present disclosure, the second node is a Type 2 node and the first node is a Type 1 node.

In some embodiments of the method according to the third broad aspect of the present disclosure, the second node is a first Type 1 node and the first node is a second Type 1 node providing a first type AI/ML model of the first node to the second node or receiving a first type AI/ML model of the second node from the second node.

In some embodiments of the method according to the third broad aspect of the present disclosure, the second node is a Type 1 node that is only associated with one or more other Type 1 nodes.

Corresponding apparatuses and devices are disclosed for performing the methods.

For example, according to another aspect of the disclosure, a device is provided that includes a processor and a memory storing processor-executable instructions that, when executed, cause the processor to carry out a method according to the first broad aspect, the second broad aspect or the third broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

By virtue of some aspects of the present disclosure, heterogeneous AI/ML capability may be enabled in various network devices and user devices and heterogeneous AI/ML model transfer over an air interface of the wireless communication network may be supported.

By virtue of some aspects of the present disclosure, a topology in a wireless communication network may be centrally configured by a network device (e.g. base station (BS), a transmit and receive point (TRP)) or a network system.

By virtue of some aspects of the present disclosure, a topology in a wireless communication network may be autonomously configured by network devices (e.g. base station (BS), a transmit and receive point (TRP)) and/or user devices as needed using a discovery procedure illustrated in the present disclosure, thereby supporting flexible topology configuration.

By virtue of some aspects of the present disclosure, a topology in a wireless communication network that is configured by various methods described in the present disclosure supports parallel AI/ML model aggregation, reduces AI/ML model routing latency, and increases robustness of AI/ML model routing.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates illustrates four EDs communicating with a network device in a communication system, according to embodiments of the present disclosure;

FIG. 6A illustrates and example of a neural network with multiple layers of neurons, according to embodiments of the present disclosure;

FIG. 6B illustrates an example of a neuron that may be used as a building block for a neural network, according to embodiments of the present disclosure;

FIG. 7 illustrates a star topology used in a conventional federated learning (FL) procedure;

FIG. 8 illustrates difference between the conventional FL-based AI/ML model training procedure and the AI/ML model learning scheme of the present disclosure;

FIGS. 9A and 9B illustrate two different types of nodes used for learning AI/ML models, in accordance with embodiments of the present disclosure;

FIG. 10 illustrates an example self-organized topology, in accordance with embodiments of the present disclosure;

FIG. 11 illustrates an example configured topology supporting AI/ML model transfer, in accordance with embodiments of the present disclosure;

FIG. 12 illustrates an example procedure to establish aggregation connection between an aggregation node and a basic node when configuring a topology for AI/ML in a wireless communication network, in accordance with embodiments of the present disclosure;

FIG. 13 illustrates an example procedure to establish aggregation connection between two aggregation nodes when configuring a topology for AI/ML in a wireless communication network, in accordance with embodiments of the present disclosure;

FIG. 14 illustrates another example procedure to establish aggregation connection between an aggregation node and a basic node when configuring a topology for AI/ML in a wireless communication network, in accordance with embodiments of the present disclosure;

FIG. 15 illustrates another example procedure to establish aggregation connection between two aggregation nodes when configuring a topology for AI/ML in a wireless communication network, in accordance with embodiments of the present disclosure;

FIG. 16 illustrates an example configured topology supporting flexible communication between aggregation nodes, in accordance with embodiments of the present disclosure;

FIG. 17 illustrates an example configured topology supporting flexible communication between aggregation nodes and basic nodes, in accordance with embodiments of the present disclosure.

Similar reference numerals may have been used in different figures to denote similar components.

### DETAILED DESCRIPTION OF ILLUSTRATIVE EMBODIMENTS

In the present disclosure, “data collection” refers to a process of collecting data by the network nodes, management entity, or user equipment (UE) for the purpose of artificial intelligence (AI)/machine learning (ML) model training, data analytics and inference.

In the present disclosure, “AI/ML Model” refers to a data driven algorithm that applies AI/ML techniques to generate a set of outputs based on a set of inputs.

In the present disclosure, “AI/ML model training” refers to a process to train an AI/ML model by learning the input/output relationship in a data driven manner and obtain the trained AI/ML model for inference.

In the present disclosure, “AI/ML inference” refers to a process of using a trained AI/ML model to produce a set of outputs based on a set of inputs.

In the present disclosure, “Online training” refers to situations where the machine learning program is not operating and taking in new information in real time.

In the present disclosure, “Offline training” refers to situations where the machine learning program is working in real time on data that comes in.

In the present disclosure, “On-UE training” refers to online/offline training at the UE.

In the present disclosure, “On-network training” refers to online/offline training at the network.

In the present disclosure, “UE-side (AI/ML) model” refers to an AI/ML model whose inference is performed entirely at the UE

In the present disclosure, “Network-side (AI/ML) model” refers to an AI/ML model whose inference is performed entirely at the network.

In the present disclosure, “Model transfer” refers to delivery of an AI/ML model over the air interface, either parameters of a model structure known at the receiving end or a new model with parameters. Delivery may contain a full model or a partial model.

In the present disclosure, “Model download” refers to model transfer from the network to UE.

In the present disclosure, “Model upload” refers to model transfer from UE to the network.

In the present disclosure, “Model deployment” refers to delivery of a fully developed and tested model runtime image to a target UE/gNodeB (gNB) where inference is to be performed.

In the present disclosure, “Federated learning/federated training” refers to a machine learning technique that trains an AI/ML model across multiple decentralized edge nodes (e.g., UEs, gNBs) each performing local model training using local data samples. The technique requires multiple model exchanges, but no exchange of local data samples.

In the present disclosure, “Model monitoring” refers to a procedure that monitors the inference performance of the AI/ML model.

In the present disclosure, “Model update” refers to retraining or fine tuning of an AI/ML model, via online/offline training, to improve the model inference performance.

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

### Example Communication Systems and Devices

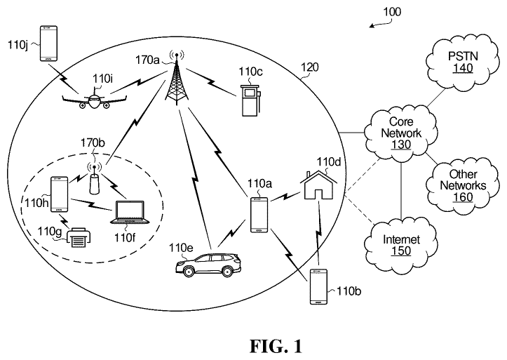

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

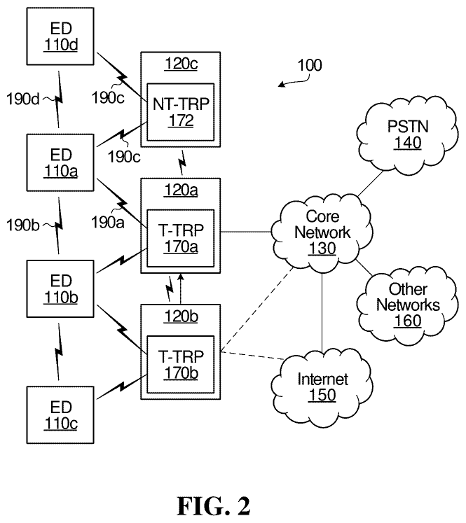

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

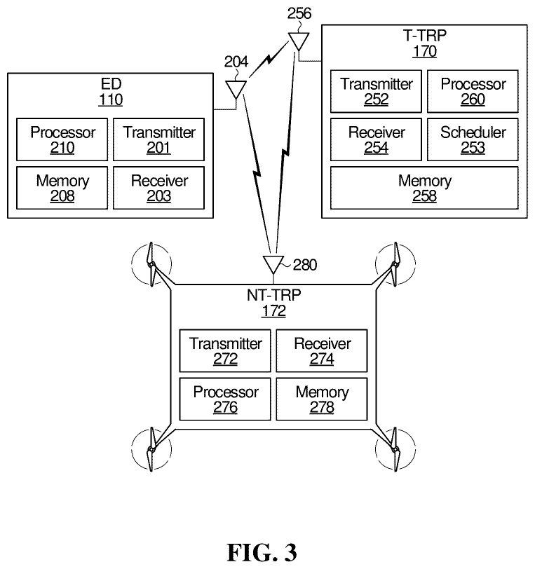

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

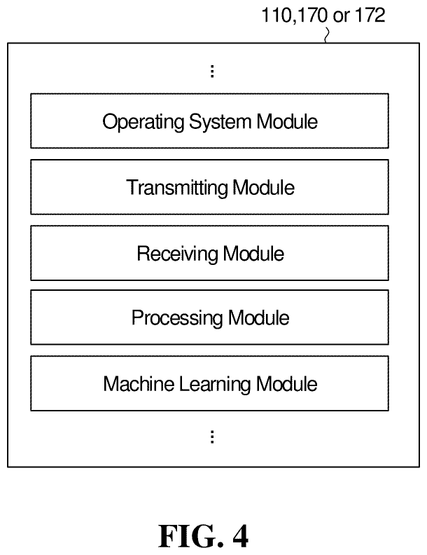

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

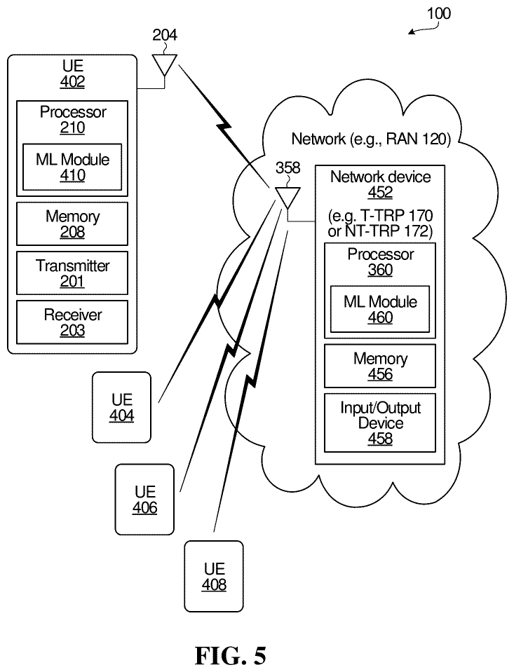

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 452 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

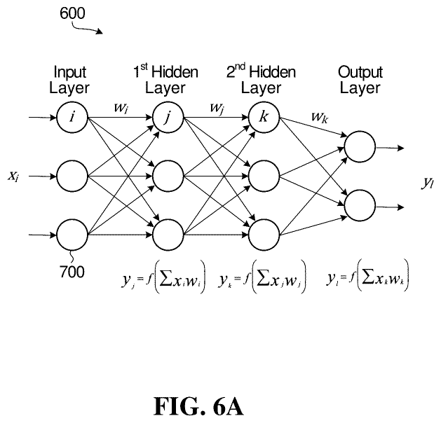

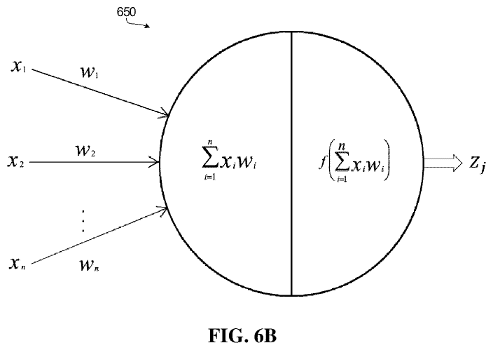

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function f( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 460, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria and the AI/ML model is finalized.

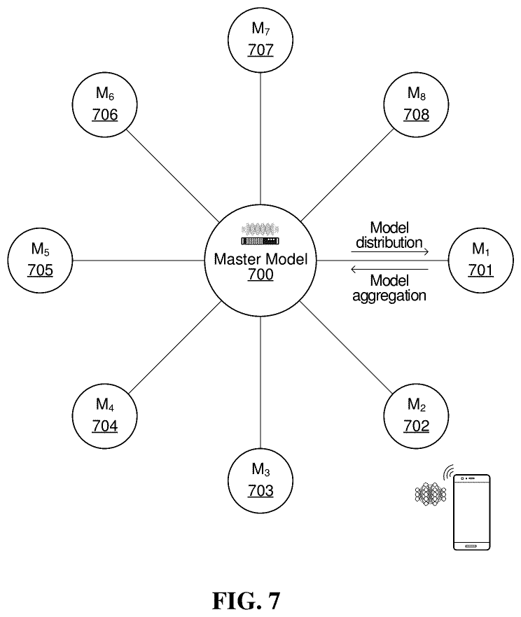

FIG. 7 illustrates an example star topology used in a conventional FL procedure. In the star topology illustrated in FIG. 7, there are a master node/device 700 (e.g. server, TRP, BS) and several client nodes/devices 701 to 708. The master node 700 initializes a master AI/ML model, samples a group of user client nodes 701 to 708, and distributes the master model (MM) to the client nodes 701 to 708. The client nodes 701 to 708 then initialize their local AI/ML models M₁ to M₈ using the master AI/ML model, and update (train) their local AI/ML models M₁ to M₈ using their own data. The client nodes 701 to 708 then report their updated local AI/ML models to the master node 700. The master node 700 aggregates the updated AI/ML models M₁ to M₈, which are reported by the client nodes 701 to 708, and updates the master AI/ML model.

Such conventional FL-based AI/ML model training procedure may have some restrictions. In the star topology used in the FL-based AI/ML model training procedure, the master node 700 needs to collect massive amount of training data set (e.g. gradients of client node update) from each of the client nodes 701 to 708. In the conventional FL-based AI training procedure, the structures of the AI/ML models (e.g. master AI/ML model and local AI/ML models) need to be same. However, since different client nodes may support different AI/ML model structures, data heterogeneity may be a problem in the conventional FL-based AI training procedure.

Aspects of the present disclosure provide solutions to overcome the aforementioned restrictions, for example specific methods and apparatuses for configuring a topology for artificial intelligence or machine learning (AI/ML) in a wireless communication network. The configured topology may support heterogeneous AI/ML model transfer over an air interface of the wireless communication network. The methods and apparatuses illustrated in the present disclosure may be implemented and deployed in consideration of computing power of each network node and potential scale-in/scale-out for AI/ML model learning and inferencing.

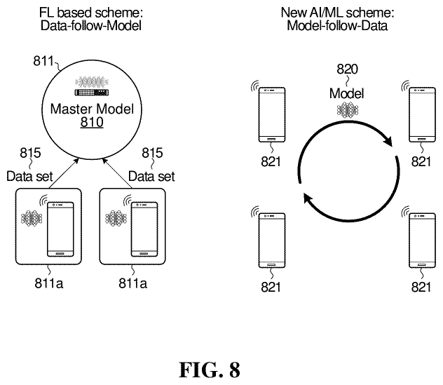

The AI/ML model learning scheme illustrated in the present disclosure is distinguished from the conventional FL-based AI/ML model training scheme. FIG. 8 illustrates difference between the conventional FL-based AI/ML model training procedure and the AI/ML model learning scheme of the present disclosure.

As illustrated in FIG. 8, the master model 810 does not move in the FL-base AI/ML model training scheme. Instead, massive amount of training data set 815 (e.g. gradients of client node update) may be transferred from client nodes 811a to a master node/device 811 which updates the master AI/ML model 810 based on the collected data. Put another way, the training data set 815 follows the AI/ML model 810 in the FL-based AI/ML model training scheme. On the contrary, in the AI/ML model learning scheme of the present disclosure, the AI/ML model 820 follows the training data set which stay at the respective network edges or nodes/devices 821. In other words, an AI/ML model 820 (e.g. a deep neural model) is routed around the network edges or nodes/devices 821 and the deep learning algorithm is executed locally at each node/device 821.

In the FL-based AI/ML model training there is only one master node/device 811 that collects AI/ML models and aggregates the collected AI/ML models. Only this master node/device 811 may be referred to as an aggregation node. On the other hand, in the AI/ML model learning scheme of the present disclosure, any node in the topology may collect AI/ML models and aggregates the collected AI/ML models, and therefore there may be several aggregation nodes (e.g. nodes 821). In effect, unlike the FL-based AI/ML model training where nodes 811 and 811a are arranged to the star-topology, a plurality of nodes/devices 821 are arranged to the self-organized topology as illustrated in FIG. 8.

Further difference between the FL-based AI/ML model training and the AI/ML model learning scheme of the present disclosure pertains to the type of data/information exchanged between the nodes. In the FL-based AI/ML model training, massive amount of training data set 815 (e.g. gradients of client node update) may be exchanged between client nodes 811a and a master node/device 811. In the AI/ML model learning scheme of the present disclosure, an AI/ML model 820 is exchanged between nodes 821.

In some embodiments, any node in the network can be a node (e.g. nodes 821 in FIG. 8) that collects one or more AI/ML models and aggregates the collected AI/ML models to generate a new or updated AI/ML model. Such node may be a Type 1 node. Type 1 node is a node configured to collect a plurality of AI/ML models and aggregate the collected AI/ML models for obtaining a new or updated AI/ML model (e.g. first type AI/ML model). Type 1 node may be also referred to as aggregation AI/ML node or aggregation node hereinafter or elsewhere in the present disclosure. Each aggregation node (or Type 1 node) may be communicatively and/or operatively connected to or associated with another aggregation node (or Type 1 node). Each aggregation node (or Type 1 node) may be communicatively and/or operatively connected to or associated with one or more other nodes. The one or more other nodes may be Type 2 nodes. Type 2 node is a node configured to train an AI/ML model (e.g. second type AI/ML model) with a set of training data (e.g. local data) without an aggregation operation. Type 2 node may be referred to as basic AI/ML node or basic node hereinafter or elsewhere in the present disclosure. In some embodiments, some aggregation nodes (or Type 1 nodes) may be associated with no basic node (or Type 2 node) (i.e. only associated with other aggregation nodes (or Type 1 nodes)).

In some embodiments, an AI/ML model may be transferred between nodes (e.g. BS, TRP, UE) according to the self-organized topology. In this respect, training gradient is not transmitted or shared between nodes (e.g. aggregation nodes and basic nodes) at the network level. This is because the training gradient is massive in quantity and difficult to control precisions in computing process.

In some embodiments, there may be at least two types of AI/ML models. The first type AI/ML model is an AI/ML model generated by an aggregation node for example based on one or more AI/ML models collected by the aggregation node. The first type AI/ML model may be referred to as common AI/ML model hereinafter or elsewhere in the present disclosure. The second type AI/ML model is an AI/ML model trained by a basic AI/ML node without aggregation operation. The second type AI/ML model may be referred to as local AI/ML model hereinafter or elsewhere in the present disclosure. It should be noted that the common AI/ML model and the local AI/ML model may have different names. A person skilled in the art would readily understand that even if an AI/ML model is referred to differently, the AI/ML model should be considered as a common AI/ML model or a local AI/ML model if the AI/ML model has characteristics essentially similar to those of the common AI/ML model or the local AI/ML model, or is generated/trained/updated in an essentially similar manner as the common AI/ML model or the local AI/ML model as described herein.

Aspects of the present disclosure provide methods for configuring or discovering a topology for artificial intelligence or machine learning (AI/ML). In some embodiments, there are two modes for topology configuration or topology discovery in a wireless communication network. In the first mode, a network device (e.g. BS or TRP) configures a topology that supports heterogeneous AI/ML model transfer over an air interface of the wireless communication network. Such configuration may be referred to as a centralized configuration. In the second mode, network devices (e.g. BSs or TRPs) and/or user devices may autonomously configure a topology in the wireless communication network. In some embodiments, an aggregation node announces its aggregation capability to other nodes. For that, the aggregation node may transmit a discovery message that includes aggregation information to be used by the other nodes for discovery of the aggregation node. In some embodiments, a node sends an aggregation request message (e.g. aggregation solicitation) to other nodes. The node sending the aggregation request message may be an aggregation node or a basic node. The aggregation request message may include an aggregation request or solicited aggregation information that the other node may be interested to discover.

In some embodiments, a topology may be configured such that AI/ML model aggregation can be processed parallelly.

In the self-organized topology, there are a plurality of nodes performing communications and computing functions. These nodes may receive at least one computing model (AI/ML model) and transmit at least one computing model (AI/ML model). While the received model and the transmitted model are not identical entity, they may have same or different data, information and/or neural network structure. The received and transmitted AI/ML models may comprise a plurality of parameters, for example one or more parameters related to a graph model, a parameters model, a model table, a model algorithm, a database.

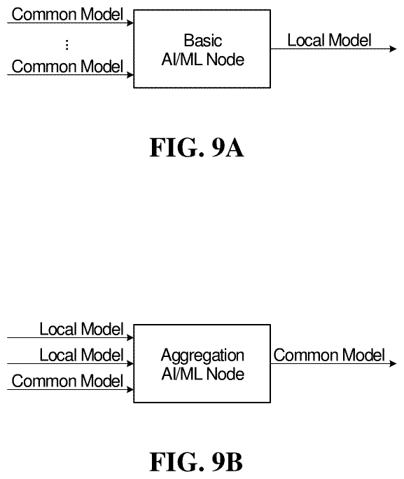

The nodes in a network may be categorized in two node types in relation to learning AI/ML models. FIGS. 9A and 9B illustrate two different types of nodes used for learning AI/ML models, in accordance with embodiments of the present disclosure. FIG. 9A illustrates one type of node that is a Type 2 node or basic AI/ML node or basic node, and FIG. 9B illustrates another type of node that is a Type 1 node or aggregation AI/ML node or aggregation node. A Type 2/basic node may be also referred to as local AI/ML node or local node.

A basic AI/ML node may receive one or more common AI/ML models from other nodes (e.g. aggregation nodes) and train its own (customized) AI/ML model. The customized AI/ML model may be referred to as local AI/ML model. The basic node trains its own local AI/ML model using its own AI/ML model training algorithm with assistance of the (current) common AI/ML models (e.g. information related to distillation and/or dilation) received from one or more aggregation nodes. In some embodiments, the neural network (NN) structure of the local AI/ML model may be same as the NN structure of at least some of the received common AI/ML models. In some embodiments, the NN structure of the local AI/ML model may be different from the NN structures of all of the received common AI/ML models. When the training of the local AI/ML model is complete, the basic node transmits the local AI/ML model to one or more other nodes (e.g. aggregation nodes).

An aggregation node may receive one or more AI/ML models from other nodes in the network. The received AI/ML models include one or more local AI/ML models from associated basic nodes and/or one or more common AI/ML models from other aggregation node(s). While the aggregation AI/ML node illustrated in FIG. 9B receives local AI/ML models, in some embodiments, the aggregation node may not receive any local AI/ML model from basic nodes (i.e. receives only common AI/ML model from other aggregation node(s)). In some embodiments, some or all of the received AI/ML models have the same NN structure. In some embodiments, all of the received AI/ML models have different NN structures. After collecting AI/ML models from other nodes, the aggregation node aggregates the collected AI/ML models (common AI/ML models, local AI/ML models) to generate a new or updated common AI/ML model. Then, the aggregation node transmits the new/updated AI/ML model to one or more other nodes.

In some embodiments, the common AI/ML model is a predefined or preconfigured AI/ML model.

As stated above, the common AI/ML models and local AI/ML models involved in AI/ML model learning process have different NN structure. For example, when an aggregation node receives one common AI/ML model and three local AI/ML models, the received AL/ML models may have all different NN structure. The common AI/ML model may be a deep neural network (DNN) model with 6 layers, a first local AI/ML model may be a DNN model with 4 layers, a second local AI/ML model may be a DNN model with 8 layers, and a third local AI/ML model may be a convolutional neural network (CNN). The NN structure may be regarded as model structure of AI/ML models.

The self-organized topology of the present disclosure includes connections between an aggregation node and one or more basic nodes and/or connections between multiple aggregation nodes.

Any network apparatus/device may be able to operate as an aggregation node in the network. An aggregation node may be communicatively and/or operatively connected to one or more basic nodes. Such connections may indicate that the aggregation node collects local AI/ML models from the associated basic nodes. However, it should be noted that in some embodiments, some aggregation node(s) may not be communicatively and/or operatively connected to any basic nodes. Such aggregation nodes may not collect local AI/ML models but only receive common AI/ML model(s) from other aggregation node(s).

It should be noted that any aggregation node and/or any basic node may be for example a UE, relay, base station (BS), transmission and reception point (TRP), edge device, edge computing system, or network system.

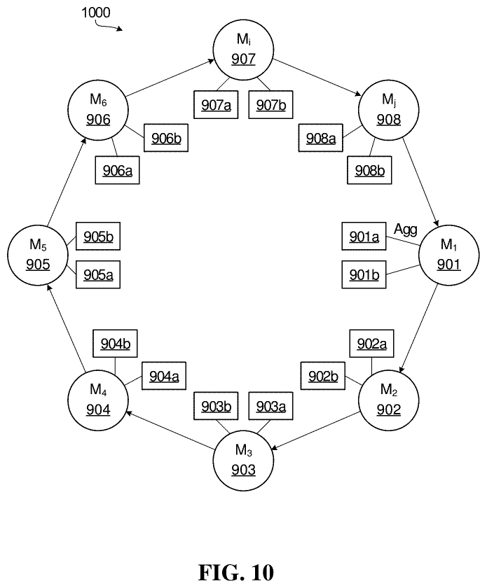

FIG. 10 illustrates an example self-organized topology 1000 in accordance with embodiments of the present disclosure. The topology 1000 includes connections between aggregation nodes and connections between aggregation nodes and basic nodes. Regarding connections between aggregation nodes, each of the aggregation nodes 901 to 908 is communicatively and operatively connected to their adjacent aggregation nodes. For example, the aggregation node 901 is communicatively and operatively connected to the aggregation nodes 902 and 908, as illustrated in FIG. 10. In this example, this connection indicates that the aggregation node 901 may receive common AI/ML model Mⱼ from the aggregation node 908 and send its common AI/ML model M₁ to the aggregation node 902.

Regarding connections between aggregation nodes and basic nodes, each of the aggregation nodes 901 to 908 is communicatively and operatively connected to basic nodes in this example. Specifically, the aggregation node 901 is communicatively and operatively connected to basic nodes 901a and 901b. These connections indicate that the aggregation node 901 may send the common AI/ML model Mⱼ received from node 908 to the basic nodes 901a and 901b and collect local AI/ML models from the basic nodes 901a and/or 901b. Similarly, the aggregation node 902 is communicatively and operatively connected to basic nodes 902a and 902b. These connections indicate that the aggregation node 902 may send the common AI/ML model M₁ received from node 901 to the basic nodes 902a and 902b and collect local AI/ML models from the basic nodes 902a and/or 902b. Further, the aggregation node 903 is communicatively and operatively connected to basic nodes 903a and 903b. These connections indicate that the aggregation node 903 may send the common AI/ML model M₂ received from node 902 to the basic nodes 903a and 903b and collect local AI/ML models from the basic nodes 903a and/or 903b. Further, the aggregation node 904 is communicatively and operatively connected to basic nodes 904a and 904b. These connections indicate that the aggregation node 904 may send the common AI/ML model M₃ received from node 903 to the basic nodes 904a and 904b and collect local AI/ML models from the basic nodes 904a and/or 904b. Further, the aggregation node 905 is communicatively and operatively connected to basic nodes 905a and 905b. These connections indicate that the aggregation node 905 may send the common AI/ML model M₄ received from node 904 to the basic nodes 905a and 905b and collect local AI/ML models from the basic nodes 905a and/or 905b. Further, the aggregation node 906 is communicatively and operatively connected to basic nodes 906a and 906b. These connections indicate that the aggregation node 906 may send the common AI/ML model M₅ received from node 905 to the basic nodes 906a and 906b and collect local AI/ML models from the basic nodes 906a and/or 906b. Further, the aggregation node 907 is communicatively and operatively connected to basic nodes 907a and 907b. These connections indicate that the aggregation node 907 may send the common AI/ML model M₆ received from node 906 to the basic nodes 907a and 907b and collect local AI/ML models from the basic nodes 907a and/or 907b. Further, the aggregation node 908 is communicatively and operatively connected to basic nodes 908a and 908b. These connections indicate that the aggregation node 908 may send the common AI/ML model Mᵢ received from node 907 to the basic nodes 908a and 908b and collect local AI/ML models from the basic nodes 908a and/or 908b.

While each basic node in FIG. 10 is communicatively and operatively connected to only one aggregation node, in some embodiments, basic nodes may be communicatively and operatively connected to more than one aggregation node. Further, while each aggregation node in FIG. 10 is communicatively and operatively connected to some basic nodes, in some embodiments, some aggregation node(s) may not be communicatively and/or operatively connected to any basic nodes. Such aggregation nodes may not collect local AI/ML models but only receive common AI/ML model(s) from other aggregation node(s).

Provided that there is an aggregation node i in a network, the aggregation node i may receive, from one or more aggregation nodes communicatively and operatively connected to the aggregation node i, information related to respective AI/ML models. Each aggregation node that sends information related to its AI/ML model may be referred to as previous aggregation node connected to the aggregation node i. The aggregation node i may send information related to its AI/ML model to one or more other aggregation nodes that are communicatively and operatively connected to the aggregation node i. Each aggregation node that receives information related to the AI/ML model of the aggregation node i may be referred to as next aggregation node connected to the aggregation node i. In the network illustrated in FIG. 10, for the aggregation node 902, the previous aggregation node is the aggregation node 901 and the next aggregation node is the aggregation node 903.

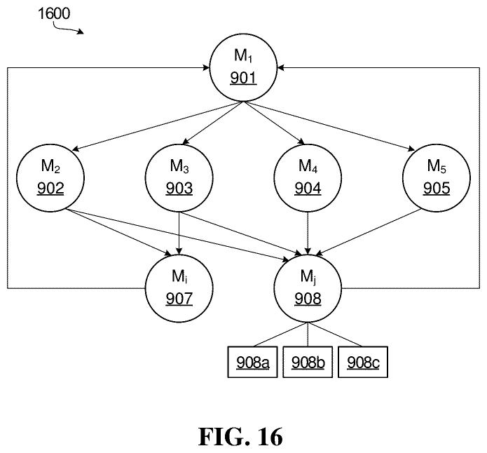

While the topology 1000 in FIG. 10 shows that each aggregation node has one previous aggregation node and one next aggregation node, it should be noted that aggregation nodes may have one or multiple previous aggregation nodes and one or multiple next aggregation nodes, as illustrated in FIG. 16. FIG. 16 shows that each aggregation node may have one or multiple previous aggregation nodes and one or multiple next aggregation nodes.

As stated above, aspects of the present disclosure provide methods for configuring a topology for AI/ML. Some methods for configuring a topology for AI/ML in a wireless communication network are illustrated below and elsewhere in the present disclosure.

According to some aspects of the present disclosure, a wireless communication network or a network device (e.g. BS, TRP) configures a topology for AI/ML in a wireless communication network. To configure the topology, the network or network device receives, from a node, information including a report related to AI/ML capability of the node. Then, the network or network device may configure the node based on the received information. The node configuration may include configuring a node type of the node. For example, the configured node type may be one of a plurality of node types that includes at least a Type 1 node type (e.g., an aggregation node) and a Type 2 node type (e.g., a basic node). As stated above, a Type 1 node is a node configured to collect a plurality of AI/ML models and aggregate the collected AI/ML models for obtaining a new or updated AI/ML model (e.g. first type AI/ML model). Also, a Type 2 node is a node configured to train an AI/ML model (e.g. second type AI/ML model) with a set of training data (e.g. local data) without aggregation operation. After the network or network device configured the node, the network or network device also configures one or more other nodes that are associated with the configured node. The network or network device may configure the one or more other nodes differently based on the node type of the configured node.

In this way, the network or network device may configure the topology for AI/ML in a wireless communication network. The configured topology may support AI/ML model transfer over an air interface of the wireless communication network. The AI/ML model transfer may be a heterogeneous AI/ML model transfer in which the AI/ML models transfer between different nodes in the topology may involve AI/ML models having different neural network structures. The AI/ML model transfer may include delivery of a full AI/ML model or a partial AI/ML model. The configured topology may include at least one of a connection between at least one aggregation node and zero or more basic nodes or a connection between at least two aggregation nodes.

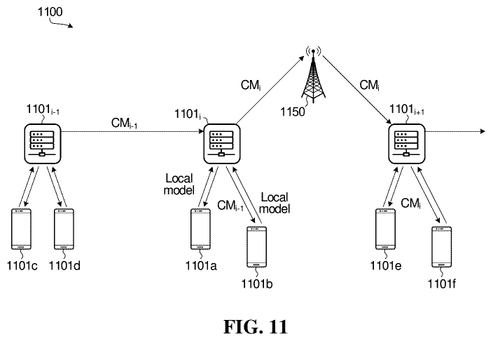

FIG. 11 illustrates an example configured topology supporting AI/ML model transfer, in accordance with embodiments of the present disclosure. Referring to FIG. 11, each of the nodes 1101ᵢ₋₁, 1101ᵢ, 1101ᵢ₊₁ and 1101a to 1101f may be a user equipment (UE), relay, base station (BS), transmission and reception point (TRP), edge device, network system, or integrated access backhauled (IAB) node. To configure the topology supporting AI/ML model transfer, the network 1100 or the network device 1150 receives, from each of the nodes 1101ᵢ₋₁, 1101ᵢ, 1101ᵢ₊₁ and 1101a to 1101f, information including a report related to its AI/ML capability. For example, the network 1100 or the network device 1150 receives, from the node 1101ᵢ, information including a report related to AI/ML capability of the node 1101ᵢ. The nodes 1101ᵢ₋₁, 1101ᵢ and 1101ᵢ₊₁ may optionally transmit an aggregation node request (i.e. a request to be configured as an aggregation node). Each node's aggregation node request may be included in said information including the report related to said node's AI/ML capability.

The network 1100 or the network device 1150 configures each node (i.e. each of the nodes 1101ᵢ₋₁, 1101ᵢ, 1101ᵢ₊₁, and 1101a to 1101f). In particular, the network 1100 or the network device 1150 configures a node type of each node. The node type of each node may be configured based on the information received from said node that includes the report related to said node's AI/ML capability. In some embodiments, each node's node type may be configured as Type 1 (e.g., aggregation node type) or Type 2 (e.g., basic node type). For example, in the case illustrated in FIG. 11, the node type of the nodes 1101ᵢ₋₁, 1101ᵢ, 1101ᵢ₊₁ may be configured as Type 1 and the node type of the nodes 1101a to 1101f may be configured as Type 2.

When a node (i.e. one of the nodes 1101ᵢ₋₁, 1101ᵢ, 1101ᵢ₊₁, and 1101a to 1101f) is configured as described above, the network 1100 or the network device 1150 may also configure one or more other nodes associated with the configured node. For example, the one or more other nodes may be configured differently based on the node type of the configured node.

For example, when the aggregation node 1101ᵢ is configured by the network 1100 or the network device 1150, at least one of the basic node 1101a, basic node 1101b, aggregation node 1101ᵢ₋₁, or aggregation node 1101ᵢ₊₁ may also be configured by the network 1100 or the network device 1150. The basic nodes 1101a and 1101b may be configured to connect with the node 1101ᵢ communicatively and operatively. The basic nodes 1101a and 1101b may be also configured to transmit their local AI/ML models to the node 1101ᵢ, respectively. The aggregation node 1101ᵢ₋₁ may be configured to be a previous aggregation node of the node 1101ᵢ such that the node 1101ᵢ₋₁ transmits the common AI/ML model CMᵢ₋₁ to the node 1101ᵢ. The aggregation node 1101ᵢ₊₁ may be configured to be a next aggregation node of the node 1101ᵢ such that the node 1101ᵢ₊₁ receives the common AI/ML model CMᵢ from the node 1101ᵢ.

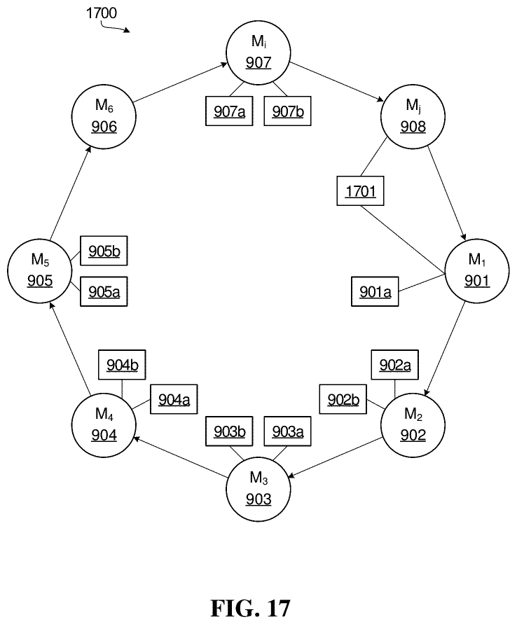

In another example, when the basic nodes 1101a and 1101b are configured by the network 1100 or the network device 1150, the aggregation node 1101ᵢ may also be configured by the network 1100 or the network device 1150. For example, the aggregation node 1101ᵢ may be configured to connect with the basic nodes 1101a and 1101b communicatively and operatively. While FIG. 11 illustrates the basic nodes 1101a and 1101b are communicatively and operatively connected to one aggregation node (i.e. node 1101ᵢ), in some embodiments, some basic nodes (e.g. node 1701 in FIG. 17) may be communicatively and operatively connected to more than one aggregation node, as illustrated in FIG. 17. In some embodiments, when the basic nodes 1101a and 1101b are configured, the aggregation node 1101ᵢ may be configured to collect local AI/ML models from the basic nodes 1101a and 1101b, respectively.

It should be noted that the nodes 1101ᵢ₋₁, 1101ᵢ, 1101ᵢ₊₁, 1101a, 1101b and other nodes included in the network 1100 may be communicatively and operatively connected in the topology over a sidelink using device-to-device (D2D) communication, through a network device (e.g. BS, TRP, etc.), or through an interface between network devices. For example, in some embodiments, the aggregation node 1101ᵢ and its associated basic nodes 1101a and 1101b may be communicatively and operatively connected through a sidelink using device-to-device (D2D) communication. In some embodiments, the aggregation nodes 1101ᵢ and 1101ᵢ₊₁ may be communicatively and operatively connected through the network device 1150. In some embodiments, the aggregation nodes 1101ᵢ and 1101ᵢ₊₁ may be communicatively and operatively connected through the network device 1150 and another network device (not shown in FIG. 11). In such case, the aggregation nodes 1101ᵢ and 1101ᵢ₊₁ may be communicatively and operatively connected through an interface between the network device 1150 and the other network device.

According to some aspects of the present disclosure, network nodes, such as user devices, may autonomously configure a topology for AI/ML in a wireless communication network. To configure the topology for AI/ML, a node (first node) transmits a message for aggregation to another node (second node). The second node determines whether to connect with the first node communicatively and operatively in order to send an AI/ML model to the first node, or to receive an AI/ML model from the first node. Then, the second node transmits a response indicative of the determination to the first node. After the first node receives the response (e.g. an aggregation acknowledgement message), the first node and the second node selectively establish an aggregation connection between them based on the second node's determination. For example, if the second node determines to connect with the first node, the second node may transmit a positive aggregation acknowledgement message to the first node. After the first node receives the positive aggregation acknowledgement message, the first node and the second node may establish a connection between them. If the second node determines not to connect with the first node, the second node may transmit a negative aggregation acknowledgement message to the first node. In such a scenario, if the first node receives a negative aggregation acknowledgement message, the connection between the first and second nodes will not be established.

In this way, network nodes (e.g. user devices) may autonomously configure the topology for AI/ML in a wireless communication network. The configured topology may support AI/ML model transfer over an air interface of the wireless communication network. The AI/ML model transfer may be a heterogeneous AI/ML model transfer. The AI/ML model transfer may include delivery of a full AI/ML model or a partial AI/ML model. The configured topology may include at least one of a connection between at least one aggregation node and zero or more basic nodes or a connection between at least two aggregation nodes.

In order to establish an aggregation connection with another node, an aggregation node may transmit information indicating its aggregation capability to the other node. In this case, the aggregation node may be referred to as an announcing node, and the other node may be referred to as a monitoring node. An announcing node is a node that transmits aggregation information that may be used by other nodes (e.g. monitoring nodes) for discovery of the announcing node. A monitoring node is a node that monitors aggregation information transmitted by an announcing node. The monitoring node may be a basic node or another aggregation node (i.e. not the announcing node). For example, when the monitoring node is another aggregation node, the monitoring node may be a previous aggregation node of the announcing node. In some embodiments, if the previous aggregation node is not found through a discovery procedure, the aggregation node (i.e. announcing node) may send a request to a network device (e.g. BS, TRP) to acquire the latest common AI/ML model, rather than receiving the latest common AI/ML model from a previous aggregation node.

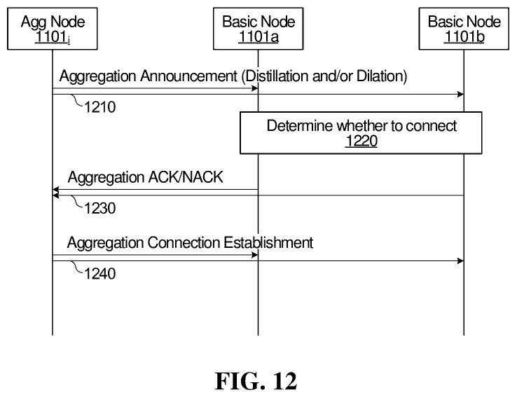

FIG. 12 illustrates an example procedure to establish an aggregation connection between an aggregation node and a basic node when configuring a topology for AI/ML in a wireless communication network, in accordance with embodiments of the present disclosure. In FIG. 12, the aggregation node 1101ᵢ is an announcing node, and the basic nodes 1101a and 1101b are monitoring nodes.

At step 1210, the aggregation node 1101ᵢ announces aggregation information. Specifically, the aggregation node 1101ᵢ transmits a discovery message to the basic nodes 1101a and 1101b. In some embodiments, the aggregation node 1101ᵢ may broadcast, groupcast or unicast the discovery message at predetermined intervals, e.g. by broadcast/groupcast/unicast RRC, MAC-CE or DCI, or interface between TRPs/BSs. The discovery message includes the aggregation information to be used by the basic nodes 1101a and 1101b for discovery of the announcing node. For example, the discovery message may include a model collection indicator, a reference AI/ML model, or both. The model collection indicator may include a distillation indicator, a dilation indicator, or a distillation and dilation indicator. Distillation and dilation operations related to AI/ML models are discussed in further detail below.

At step 1220, if the basic nodes 1101a and 1101b are interested in the discovery message received from the aggregation node 1101ᵢ, the basic nodes 1101a and 1101b may read and process the received discovery message. Then, the basic nodes 1101a and 1101b may determine whether to connect with the aggregation node 1101ᵢ communicatively and operatively.

At step 1230, the basic nodes 1101a and 1101b may transmit their responses to the aggregation node 1101ᵢ, respectively. Each response indicates whether the basic node 1101a or 1101b has determined to connect with the aggregation node 1101ᵢ. In some embodiments, the response is either a positive aggregation acknowledgement message or a negative aggregation acknowledgement message. For example, the basic node 1101a may determine to connect with the aggregation node 1101ᵢ and the basic node 1101b may determine not to connect with the aggregation node 1101ᵢ. In this case, the basic node 1101a transmits a positive aggregation acknowledgement message (e.g. ACK) to the aggregation node 1101ᵢ node, and the basic node 1101b transmits a negative aggregation acknowledgement message (e.g. NACK) to the aggregation node 1101ᵢ.

At step 1240, after the aggregation node 1101ᵢ receives the responses, the aggregation node 1101ᵢ selectively establishes aggregation connection(s) with one or both of the basic nodes 1101a and 1101b based on the received response. In the illustrated example, it is assumed that the basic nodes 1101a and 1101b both respond with a positive aggregation acknowledgement message at step 1230, and therefore the aggregation node 1101i establishes an aggregation connection with each of the basic nodes 1101a and 1101b at step 1240. On the other hand, the aggregation node 1101ᵢ may not establish an aggregation connection with any associated basic node that responds with a negative aggregation acknowledgement message at step 1230.

After aggregation connections between the aggregation node 1101ᵢ and the basic nodes 1101a and 1101b are established using the above discovery procedure, the aggregation node 1101ᵢ may collect local AI/ML models from the basic nodes 1101a and 1101b, and perform aggregation operation to generate a new or updated common AI/ML model.

For example, referring again to FIG. 11, after aggregation connections between the aggregation node 1101ᵢ and the basic nodes 1101a and 1101b are established, the node 1101ᵢ may receive an AI/ML model CMᵢ₋₁ from the node 1101ᵢ₋₁. For example, the AI/ML model CMᵢ₋₁ may be communicated by the node 1101ᵢ₋₁ by broadcast, groupcast, or unicast signaling, e.g. by broadcast/groupcast/unicast RRC, MAC-CE or DCI, or interface between TRPs/BSs. After receiving the AI/ML model CMᵢ₋₁, the node 1101ᵢ may transmit the AI/ML model CMᵢ₋₁ to one or more of its associated nodes 1101a and 1101b. For example, the AI/ML model CMᵢ₋₁ may be communicated by the node 1101ᵢ by broadcast, groupcast, or unicast signaling, e.g. by broadcast/groupcast/unicast RRC, MAC-CE or DCI, or interface between TRPs/BSs.

After receiving the AI/ML model CMᵢ₋₁ transmitted by the node 1101ᵢ. the associated nodes 1101a and 1101b may train their respective AI/ML models. Each of these AI/ML models may be a local AI/ML model of one of the associated nodes 1101a and 1101b. Each of the associated nodes 1101a and 1101b may train its (associated) AI/ML model with at least one of its own training dataset, its own AI/ML algorithm (e.g. AI/ML model training algorithm), or the AI/ML model CMᵢ₋₁ received from the node 1101ᵢ. In some embodiments, the training may be performed based on the AI/ML model CMᵢ₋₁ received from the node 1101ᵢ by transfer learning, knowledge distillation and/or knowledge dilation. The AI/ML model CMᵢ₋₁ and associated AI/ML models of the associated nodes 1101a and 1101b may have the same input and/or output types. However, the AI/ML model CMᵢ₋₁ and the associated AI/ML models of the associated nodes 1101a and 1101b may have different neural network (NN) structures. In other words, the associated AI/ML models of the associated nodes 1101a and 1101b are not required to have NN structures equivalent to the NN structure of the AI/ML model CMᵢ₋₁.

In some embodiments, the node 1101ᵢ may transmit an indicator to collect AI/ML models from the associated nodes 1101a and 1101b. For example, the indicator may be communicated by the node 1101ᵢ by broadcast, groupcast, or unicast signaling, e.g. by broadcast/groupcast/unicast RRC, MAC-CE or DCI, or interface between TRPs/BSs. This indicator may be referred to as a model collection indicator. The node 1101ᵢ may transmit the model collection indicator to the associated nodes 1101a and 1101b to request reports related to respective associated AI/ML models of the associated nodes 1101a and 1101b. In some embodiments, the reports related to the associated AI/ML models of the associated nodes 1101a and 1101b are generated by the associated nodes 1101a and 1101b based on the model collection indicator. In such embodiments, the model collection indicator may be a dynamic indicator or an event-triggered indicator. For example, if the model collection indicator is a dynamic indicator, the node 1101ᵢ may receive the reports related to the respective associated AI/ML models of the associated nodes 1101a and 1101b from the associated nodes 1101a and 1101b at respective times that are preconfigured by the node 1101ᵢ. On the other hand, if the model collection indicator is an event-triggered indicator, the associated nodes 1101a and 1101b may transmit their respective reports when a certain event is triggered. The event may be triggered when trainings of the respective associated AI/ML models of the associated nodes 1101a and 1101b are completed or performances of the respective associated AI/ML models of the associated nodes exceed a certain performance measure. Said certain performance measure may be predetermined based on at least one of accuracy or precision. If performance of one of the associated AI/ML models does not exceed the predetermined performance measure (e.g. accuracy is lower than the predetermined accuracy measure), the report related to that AI/ML model may not be generated and/or transmitted to the node 1101ᵢ (e.g. no local AL/ML model report transmission).

In some embodiments, each of the associated nodes 1101a and 1101b optionally sends an acknowledgement indicator for transmissions of its associated AI/ML model. For example, the acknowledgement indicator may be communicated by PUCCH or PUSCH, or sidelink channel, or an interface between TRPs/BSs. The positive acknowledgement indicator (e.g. ACK) indicates that the report related to the associated AI/ML model will be transmitted. The negative acknowledgement indicator (e.g. NACK) indicates that the report related to the associated AI/ML model will not be transmitted (e.g. no associated AI/ML model will be reported). In some embodiments, the acknowledgement indicator may be transmitted before the transmission of the report related to the associated AI/ML model. In some other embodiments, the acknowledgement indicator is included in the report related to the associated AI/ML model.

The associated nodes 1101a and 1101b may then transmit, to the node 1101ᵢ, the reports related to the associated AI/ML models of the associated nodes 1101a and 1101b. In some embodiments, the report related to the associated AI/ML models of the associated nodes 1101a and 1101b may include at least one of information related to the respective associated AI/ML models of the associated nodes 1101a and 1101b, information related to training data for the respective associated AI/ML models of the associated nodes 1101a and 1101b, or information related to performance of the respective associated AI/ML models of the associated nodes 1101a and 1101b. The information related to the respective associated AI/ML models may include NN structures of the associated nodes 1101a and 1101b (NN algorithm, width, depth, etc.) and/or one or more AI/ML parameters (weight, bias, activation function, etc.) The information related to training data for the respective associated AI/ML models may include amount (volume) of training data and/or information related to training data distribution. The information related to performance of the respective associated AI/ML models may include accuracy, precision, recall, loss information (e.g. average cross-entropy loss), validation/test data set configured by the node 1100ᵢ (or other aggregation node or a BS). It should be noted that, in some embodiments, the information related to training data for the respective associated AI/ML models and/or the information related to performance of the respective associated AI/ML models may assist aggregation operation of aggregation nodes. For example, the training data information and/or the performance information may be used to determine AI/ML model aggregation weight.

After the node 1101ᵢ receives the reports related to the respective associated AI/ML models of the associated nodes 1101a and 1101b, the node 1101ᵢ generates an AI/ML model CMᵢ based on the received reports. The AI/ML model CMᵢ may be an updated common AI/ML model. The AI/ML models CMᵢ₋₁ and CMᵢ may have the same NN structure. In some embodiments, the node 1101ᵢ generates the AI/ML model CMᵢ using an aggregation algorithm (e.g. model distillation, model dilation). In some embodiments, the node 1200ᵢ may generate its own AI/ML model. This AI/ML model may be a local AI/ML model. This AI/ML model may be generated without reports related to the respective associated AI/ML models of the associated nodes 1101a and 1101b.

The node 1101ᵢ may then transmits the AI/ML model CMᵢ to the node 1101ᵢ₊₁. The AI/ML model CMᵢ may include one or more AI/ML model parameters (e.g. weight, bias) but not include information related to the NN structure of the AI/ML model CMᵢ. In other words, information related to the NN structure of the AI/ML model CMᵢ may not be transmitted from the node 1101ᵢ to the node 1101ᵢ₊₁, as the NN structure of the AI/ML model CMᵢ may be pre-configured and/or the NN structure of the AI/ML model CMᵢ may be known at the node 1101ᵢ₊₁. In some embodiments, the AI/ML model CMᵢ transmitted to the node 1200ᵢ may be a full AI/ML model or a partial AI/ML model.

As stated above, the associated AI/ML models of the associated nodes 1101a and 1101b are not restricted to have NN structures that are equivalent to the NN structure of the AI/ML model CMᵢ₋₁ and the AI/ML model CMᵢ. In other words, heterogeneous AI/ML model aggregation may be enabled by configuring a topology for AI/ML in a wireless communication network, in accordance with embodiments of the present disclosure. For example, in some embodiments, the AI/ML model CMᵢ₋₁ received by the node 1101ᵢ from the previous node 1101ᵢ₋₁ and the AI/ML model CMᵢ generated by the AI/ML model based on the reports received by the node 1101ᵢ from its associated nodes 1101a and 1101b may both include a NN with 4 layers, but the local AI/ML model generated by the associated node 1101a and/or 1101b may have different NN structures. For example, the local AI/ML model generated by the associated node 1101a may include a NN with 5 layers, and the local AI/ML model generated by the associated node 1101b may include a NN with 3 layers.

After receiving reports related to local AI/ML models of its associated nodes 1101a and 1101b, the node 1101ᵢ may perform an aggregation operation (e.g. model distillation, model dilation) to generate the AI/ML model CMᵢ based on the local AI/ML models generated by the associated nodes 1101a and 1101b. As each of the local AI/ML models generated by the associated node 1101a and 1101b may have different importance (significance) for generation of the AI/ML model CMᵢ, each of the local AI/ML models generated by the associated nodes 1101a and 1101b may be weighted with a respective weighting, e.g., Wₐ and W_{b}, when aggregating the local AI/ML models. Wₐ and W_{b} may indicate importance of the local AI/ML models generated by the associated nodes 1101a and 1101b. The generated AI/ML model CMᵢ may be an updated common AI/ML model. The NN structure of CMᵢ may be the same as that of the AI/ML model CMᵢ₋₁. In this case, both the AI/ML model CMᵢ and AI/ML model CMᵢ₋₁ could include a NN with 4 layers, for example.

However, as noted above, the AI/ML model CMᵢ and the local AI/ML models LM₁, LM₂ and LM₃ may have different neural network (NN) structures. The local AI/ML models generated by the associated nodes 1101a and 1101b are not required to have NN structures equivalent to the NN structure of the common AI/ML models in order to generate an AI/ML models CMᵢ. In other words, heterogeneous AI/ML model aggregation over the self-organized topology is enabled.

In some embodiments, an aggregation node receives one or more heterogeneous AI/ML models from one or more associated basic nodes communicatively and operatively connected to the aggregation node. The aggregation node may distill and/or dilate the received heterogeneous AI/ML models. Then, the aggregation may aggregate the distilled and/or dilated AI/ML models to generate a new or updated common AI/ML model. In some embodiments, the aggregation node may obtain an average of the distilled AI/ML models and/or average of the dilated AI/ML models. After obtaining the common AI/ML model, the aggregation node may send the new/updated common AI/ML model to one or more other nodes which may be next aggregation nodes.

As stated above, an aggregation node may distill and/or dilate AI/ML models if the NN structures of the aggregation node's associated basic nodes differ from that of the aggregation node's common AI/ML model. Otherwise, if the NN structures of the aggregation node's associated basic nodes are the same as that of the aggregation node's common AI/ML model, then no distillation and/or dilation operation may be performed. The distillation and/or dilation may be part of the aggregation operation of the aggregation node. The distillation may include generating, from an AI/ML model received by the node, a smaller AI/ML model, and the dilation may include generating, from an AI/ML model received by the node, a bigger AI/ML model. Therefore, distillation of the aggregation node may include generating, by the aggregation node, a common AI/ML that is smaller than the AI/ML models received from other nodes (e.g. local AI/ML model received from associated basic nodes). Similarly, dilation of the aggregation node may include generating, by the aggregation node, a common AI/ML model that is bigger than the AI/ML models received from other nodes (e.g. local AI/ML model received from associated basic nodes).

For the purpose of illustrating distillation and/or dilation, when a first AI/ML model is bigger than a second AI/ML model, the first AI/ML model may have a greater number of floating-point operations than the second model, a greater number of total parameters than the second model, a greater number of trainable parameters than the second model, larger required buffer size than the second model, width greater than the second model, depth greater than the second model, or any combination thereof. Similarly, for the purpose of illustrating distillation and/or dilation, when a first AI/ML model is smaller than a second AI/ML model, the first AI/ML model may have a fewer number of floating-point operations than the second model, a fewer number of total parameters than the second model, a fewer number of trainable parameters than the second model, smaller required buffer size than the second model, width less than the second model, depth less than the second model, or any combination thereof.

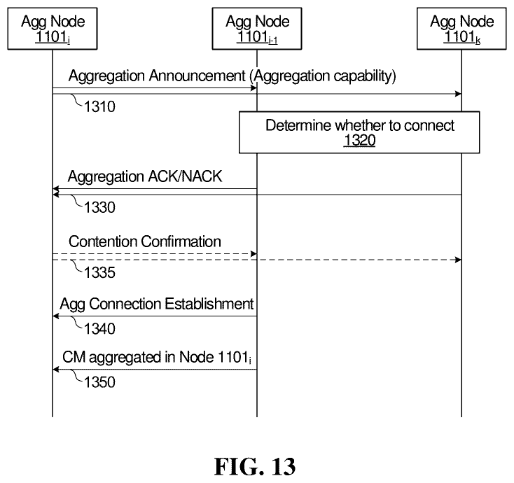

FIG. 13 illustrates an example procedure to establish aggregation connection between two aggregation nodes when configuring a topology for AI/ML in a wireless communication network, in accordance with embodiments of the present disclosure. In FIG. 13, the aggregation node 1101ᵢ is an announcing node, and the aggregation nodes 1101ᵢ₋₁ and 1101ₖ are monitoring nodes. The aggregation nodes 1101ᵢ₋₁ may be a previous aggregation node of the aggregation node 1101ᵢ.

At step 1310, the aggregation node 1101ᵢ announces aggregation information. Specifically, the aggregation node 1101ᵢ transmits a discovery message to the aggregation nodes 1101ᵢ₋₁ and 1101ₖ. In some embodiments, the aggregation node 1101ᵢ may broadcast, groupcast or unicast the discovery message at predetermined intervals. The discovery message includes the aggregation information to be used by the aggregation nodes 1101ᵢ₋₁ and 1101ₖ for discovery of the announcing node. For example, the aggregation information to be used by the aggregation nodes 1101ᵢ₋₁ and 1101ₖ may include aggregation capability of the aggregation node 1101ᵢ.

At step 1320, if the aggregation nodes 1101ᵢ₋₁ and 1101ₖ are interested in the discovery message received from the aggregation node 1101ᵢ, the aggregation nodes 1101ᵢ₋₁ and 1101ₖ may read and process the received discovery message. Then, the aggregation nodes 1101ᵢ₋₁ and 1101ₖ may determine whether to connect with the aggregation node 1101ᵢ communicatively and operatively.

At step 1330, the aggregation nodes 1101ᵢ₋₁ and 1101ₖ may transmit their responses to the aggregation node 1101ᵢ, respectively. Each response indicates whether the aggregation node 1101ᵢ₋₁ or 1101ₖ has determined to connect with the aggregation node 1101ᵢ. In some embodiments, the response is either a positive aggregation acknowledgement message or a negative aggregation acknowledgement message. For example, the aggregation node 1101ᵢ₋₁ may determine to connect with the aggregation node 1101ᵢ and the aggregation node 1101ₖ may determine not to connect with the aggregation node 1101ᵢ. In this case, the aggregation nodes 1101ᵢ₋₁ transmits a positive aggregation acknowledgement message (e.g. ACK) to the aggregation node 1101ᵢ node, and the aggregation node 1101ₖ transmits a negative aggregation acknowledgement message (e.g. NACK) to the aggregation node 1101ᵢ.

In some embodiments, an aggregation node may be communicatively and operatively connected to only one other aggregation node. For example, the aggregation node in the network may have one-to-one relationship with the other aggregation node. In such embodiments, the announcing aggregation node transmits, to monitoring aggregation nodes, contention confirmations informing whether connection to the announcing node is successfully established. In FIG. 13, if the aggregation node 1101ᵢ is capable of connecting only with one of the aggregation nodes 1101ᵢ₋₁ and 1101ₖ, the aggregation node 1101ᵢ, at step 1335, optionally transmits contention confirmations to the aggregation nodes 1101ᵢ₋₁ and 1101ₖ to inform whether each of them is successfully connected to the aggregation node 1101ᵢ.

At step 1340, with an assumption that the aggregation node 1101ᵢ is capable of connecting only with the aggregation node 1101ᵢ₋₁, the aggregation node 1101ᵢ establishes an aggregation connection with the aggregation node 1101ᵢ₋₁ based on the received response, the contention confirmation, or both. No aggregation connection is established between the aggregation node 1101ᵢ and the aggregation node 1101ₖ.

After the aggregation connection between the aggregation node 1101ᵢ and the aggregation node 1101ᵢ₋₁ is established, the aggregation node 1101ᵢ may receive a common AI/ML model from the aggregation node 1101ᵢ₋₁.

In order to establish an aggregation connection with another node, a node may transmit an aggregation request message (e.g. aggregation solicitation) to the other node. In this case, the node transmitting the aggregation request message may be referred to as a discoverer node, and the other node receiving the aggregation request message may be referred to as a discoveree node. If the discoverer node is a basic node, the discoverer node may transmit the aggregation request message to the associated aggregation node. If the discoverer node is an aggregation node, the discoverer node may transmit the aggregation request message to other aggregation node to request the other aggregation node as a next hop (e.g. request the other aggregation to be the next aggregation node). In some embodiments, if the next aggregation node is not found through a discovery procedure, the aggregation node (discoverer node) may send the aggregated common AI/ML model to a network device (e.g. BS, TRP).

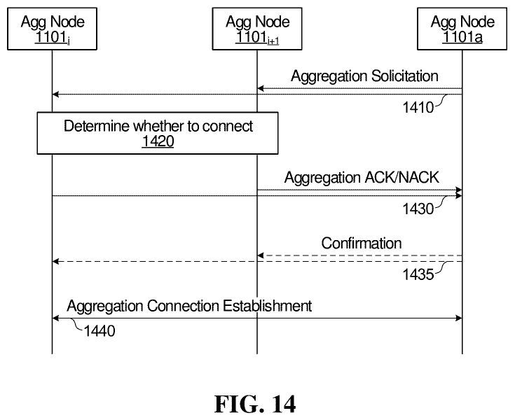

FIG. 14 illustrates another example procedure to establish aggregation connection between an aggregation node and a basic node when configuring a topology for AI/ML in a wireless communication network, in accordance with embodiments of the present disclosure. In FIG. 14, the basic node 1101a is a discoverer node, and the aggregation nodes 1101ᵢ and 1101ᵢ₊₁ are discoveree nodes.

At step 1410, the basic node 1101a transmits an aggregation request message to the aggregation nodes 1101ᵢ and 1101ᵢ₊₁. In some embodiments, the basic node 1101a may broadcast, groupcast or unicast the aggregation request message at predetermined intervals. The aggregation request message may include a solicited aggregation information that the basic node 1101a is interested to discover. Provided that the basic node 1101a is the discoverer node, the aggregation request message may include information related to a local AI/ML model of the basic node 1101a. The information related to the local AI/ML model of the basic node 1101a may include information related to neural network of the local AI/ML model of the basic node 1101a, information related to size of the local AI/ML model of the basic node 1101a, or information related to complexity of the local AI/ML model of the basic node 1101a. In some embodiments, the information related to the local AI/ML model size and/or complexity may be relative size and/or complexity of the local AI/ML model in comparison with a reference AI/ML model.

At step 1420, if the aggregation nodes 1101ᵢ and 1101ᵢ₊₁ are interested in the aggregation request message received from the basic node 1101a, the aggregation nodes 1101ᵢ and 1101ᵢ₊₁ may read and process the received aggregation request message. Then, the aggregation nodes 1101ᵢ and 1101ᵢ₊₁ may determine whether to connect with the basic node 1101a communicatively and operatively. For example, if the discoveree aggregation node 1101ᵢ has distillation capability and the discoverer basic node 1101a reports a bigger AI/ML model than a reference AI/ML model, then the aggregation node 1101ᵢ determines to communicatively and operatively connect with the basic node 1101a. If the discoveree aggregation node 1101ᵢ₊₁ has dilation capability and the discoverer basic node 1101a reports a smaller AI/ML model than the reference AI/ML model, then the aggregation node 1101ᵢ₊₁ determines to communicatively and operatively connect with the basic node 1101a.

At step 1430, the aggregation nodes 1101ᵢ and 1101ᵢ₊₁ may transmit their responses to the basic node 1101a, respectively. Each response indicates whether the aggregation nodes 1101ᵢ or 1101 in has determined to connect with the basic node 1101a. In some embodiments, the response is either a positive aggregation acknowledgement message or a negative aggregation acknowledgement message. For example, the aggregation node 1101ᵢ may determine to connect with the basic node 1101a and the aggregation node 1101ᵢ₊₁ may determine not to connect with the basic node 1101a, because the discoveree aggregation node 1101ᵢ has distillation capability and the discoveree aggregation node 1101ᵢ₊₁ has dilation capability and the discoverer basic node 1101a reports a bigger AI/ML model than the reference AI/ML model. In such case, the aggregation node 1101ᵢ transmits a positive aggregation acknowledgement message (e.g. ACK) to basic node 1101a, and the aggregation node 1101ᵢ₊₁ transmits a negative aggregation acknowledgement message (e.g. NACK) to the basic node 1101a.

At step 1435, the basic node 1101a may optionally transmit contention confirmations to the aggregation nodes 1101ᵢ and 1101ᵢ₊₁ to confirm whether each of them is successfully connected to the basic node 1101a.

At step 1440, the basic node 1101a establishes an aggregation connection with the aggregation node 1101ᵢ based on the received response, the contention confirmation, or both. No aggregation connection is established between the basic node 1101a and the aggregation node 1101ᵢ₊₁.

After the aggregation connection between the basic node 1101a and the aggregation node 1101ᵢ is established by the discovery procedure, the aggregation node 1101ᵢ may collect a local AI/ML model from the basic node 1101a and perform an aggregation operation to generate a new or updated common AI/ML model.

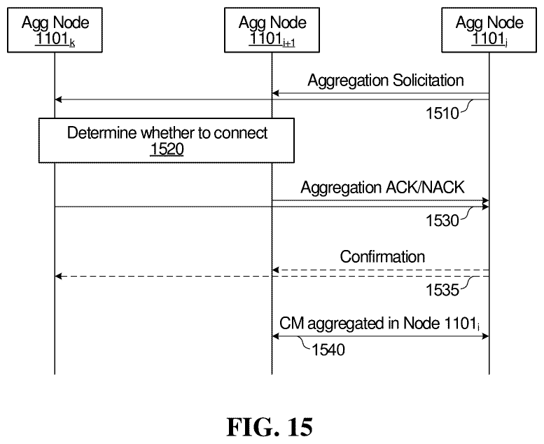

FIG. 15 illustrates another example procedure to establish an aggregation connection between two aggregation nodes when configuring a topology for AI/ML in a wireless communication network, in accordance with embodiments of the present disclosure. In FIG. 15, the aggregation node 1101ᵢ is a discoverer node, and the aggregation nodes 1101ᵢ₊₁ and 1101ₖ are discoveree nodes. The aggregation nodes 1101ᵢ₊₁ may be a next aggregation node of the aggregation node 1101ᵢ.

At step 1510, the aggregation node 1101ᵢ transmits an aggregation request message to the aggregation nodes 1101ₖ and 1101ᵢ₊₁. In some embodiments, the aggregation node 1101ᵢ may broadcast, groupcast or unicast the aggregation request message at predetermined intervals, e.g. by broadcast/groupcast/unicast RRC, MAC-CE or DCI, or interface between TRPs/BSs. The aggregation request message may include an aggregation request from the aggregation node 1101ᵢ.

At step 1520, if the aggregation nodes 1101ₖ and 1101ᵢ₊₁ are interested in the aggregation request message received from the aggregation node 1101ᵢ, the aggregation nodes 1101ₖ and 1101ᵢ₊₁ may read and process the received aggregation request message. Then, the aggregation nodes 1101ₖ and 1101ᵢ₊₁ may determine whether to connect with the aggregation node 1101ᵢ communicatively and operatively.

At step 1530, the aggregation nodes 1101ₖ and 1101ᵢ₊₁ may transmit their responses to the aggregation node 1101ᵢ, respectively. Each response indicates whether the aggregation nodes 1101ₖ or 1101ᵢ₊₁ has determined to connect with the aggregation node 1101ᵢ. In some embodiments, the response is either a positive aggregation acknowledgement message or a negative aggregation acknowledgement message. For example, the aggregation node 1101ᵢ₊₁ may determine to connect with the aggregation node 1101ᵢ and the aggregation node 1101ₖ may determine not to connect with the aggregation node 1101ᵢ. In this case, the aggregation nodes 1101ᵢ₊₁ transmits a positive aggregation acknowledgement message (e.g. ACK) to the aggregation node 1101ᵢ node, and the aggregation node 1101ₖ transmits a negative aggregation acknowledgement message (e.g. NACK) to the aggregation node 1101ᵢ.

In some embodiments, a discoverer aggregation node may be communicatively and operatively connected to only one other aggregation node. For example, the discoverer aggregation node in the network may have one-to-one relationship with the other aggregation node. In such embodiments, the discoverer aggregation node transmits, to discoveree aggregation nodes, contention confirmations informing whether connection to the discoverer node is successfully established. In FIG. 15, if the discoverer aggregation node 1101ᵢ is capable of connecting only with one of the discoveree aggregation nodes 1101ₖ and 1101ᵢ₊₁, the discoverer aggregation node 1101ᵢ, at step 1535, optionally transmits contention confirmations to the discoveree aggregation nodes 1101ₖ and 1101ᵢ₊₁ to confirm whether each of them is successfully connected to the aggregation node 1101ᵢ.

At step 1540, with an assumption that the aggregation node 1101ᵢ is capable of connecting only with the aggregation node 1101ᵢ₊₁, the aggregation node 1101ᵢ establishes an aggregation connection with the aggregation node 1101 in based on the received response, the contention confirmation, or both. No aggregation connection is established between the aggregation node 1101ᵢ and the aggregation node 1101ₖ.

After the aggregation connection between the aggregation node 1101ᵢ and the aggregation node 1101ᵢ₊₁ is established by the discovery procedure, the discoveree aggregation node 1101ᵢ₊₁ may receive a common AI/ML model from the discoverer aggregation node 1101ᵢ.

According to some aspects of the present disclosure, a topology for AI/ML in a wireless communication network may be configured such that AI/ML model aggregation may be processed parallelly among multiple aggregation nodes. In other words, the topology configured based on methods illustrated in the present disclosure may be flexible.

In some embodiments, a topology for AI/ML in a wireless communication network may be configured such that each aggregation node is connected to one or multiple aggregation nodes as illustrated in FIG. 16. FIG. 16 illustrates an example configured topology 1600 supporting flexible communication between aggregation nodes, in accordance with embodiments of the present disclosure.

In the configured topology 1600, an aggregation node may transmit a common AI/ML model to one or more AI/ML aggregation nodes. For example, the aggregation node 901 transmits the common AI/ML model M₁ to the aggregation nodes 902, 903, 904 and 905. On the other hand, the aggregation node 907 transmits the common AI/ML model Mᵢ only to the aggregation node 901. It should be noted that the aggregation nodes in FIG. 16 may transmit their common AI/ML models via broadcast, groupcast or unicast signaling, e.g. by broadcast/groupcast/unicast RRC, MAC-CE or DCI, or interface between TRPs/BSs.

In the configured topology 1600, an aggregation node may receive common AI/ML models from multiple AI/ML aggregation nodes. For example, the aggregation node 908 receives the AI/ML models M₂, M₃, M₄ and M₅ from the aggregation nodes 902, 903, 904 and 905, respectively.

In relation to AI/ML model aggregation, behaviors of the aggregation is illustrated below using the aggregation node 908. The aggregation node 908, as stated above, receives the AI/ML models M₂, M₃, M₄ and M₅ from the aggregation nodes 902, 903, 904 and 905, respectively. Then, the aggregation node 908 aggregates the received AI/ML models M₂, M₃, M₄ and M₅. In some embodiments, the aggregation node 908 may calculate an average of the AI/ML models M₂, M₃, M₄ and M₅ to obtain an aggregated AI/ML model. After obtaining the aggregated AI/ML model, the aggregation node 908 sends the aggregated AI/ML model to its associated basic nodes, which in this example include three basic nodes 908a, 908b and 908c that are communicatively and operatively connected to the aggregation node 908. The basic nodes 908a, 908b and 908c train their local AI/ML models using the aggregated common AI/ML model transmitted from the aggregation node 908. When the training is complete, the aggregation node 908 collects the local AI/ML models from the basic nodes 908a, 908b and 908c. Then, the aggregation node 908 aggregates the collected local AI/ML models to generate an updated common AI/ML model Mⱼ. The aggregation node 908 may transmit the updated common AI/ML model to its next aggregation node 901.

In some embodiments, a topology for AI/ML in a wireless communication network may be configured such that each basic node is connected to zero or more aggregation nodes as illustrated in FIG. 17. FIG. 17 illustrates an example configured topology 1700 supporting flexible communication between aggregation nodes and basic nodes, in accordance with embodiments of the present disclosure.

In the configured topology 1700, each of the aggregation nodes 901 to 905, 907 and 908 is communicatively and operatively connected to one or more basic nodes. For example, the aggregation node 901 is communicatively and operatively connected to basic nodes 901a and 1701. However, the aggregation node 906 is not communicatively and operatively connected to any basic node. As the aggregation node 906 has no associated basic node, the aggregation node 906 may generate an updated common AI/ML model in a different manner. For example, the aggregation node 906 receives a common AI/ML model from another aggregation node (e.g. aggregation node 905), and the aggregation node 906 generates its own local AI/ML model. Then, the aggregation node 906 calculates an average of the received common AI/ML model and its own local AI/ML model to form an updated common AI/ML model. When the aggregation node 906 obtains the updated common AI/ML model, the aggregation node 906 transmits the updated AI/ML model to its next aggregation node (e.g. aggregation node 907).

In the configured topology 1700, each basic node is communicatively and operatively connected to one or multiple aggregation nodes. For example, the basic node 901a is communicatively and operatively connected to one aggregation node 901.

On the other hand, the basic node 1701 is communicatively and operatively connected to two aggregation nodes 901 and 908. The connection of the basic node 1701 may be implemented using a network device (e.g. BS). For example, the network device broadcasts multiple local AI/ML models (each local AI/ML model has an AI/ML model identifier). The network device indicates a set of AI/ML model identifiers to be aggregated by each aggregation node. When the network device indicates the AI/ML model identifiers, the same AI/ML model identifier may be assigned to multiple aggregation nodes. Thus, the identifier for the local AI/ML model associated with the basic node 1701 may be assigned to both of the aggregation nodes 901 and 908.

By virtue of some aspects of the present disclosure, heterogeneous AI/ML capability may be enabled in various network devices and user devices and heterogeneous AI/ML model transfer over an air interface of the wireless communication network may be supported.

By virtue of some aspects of the present disclosure, a topology in a wireless communication network may be centrally configured by a network device (e.g. base station (BS), a transmit and receive point (TRP)) or a network system.

By virtue of some aspects of the present disclosure, a topology in a wireless communication network may be autonomously configured by network devices (e.g. base station (BS), a transmit and receive point (TRP)) and/or user devices as needed using a discovery procedure illustrated in the present disclosure, thereby supporting flexible topology configuration.

By virtue of some aspects of the present disclosure, a topology in a wireless communication network that is configured by various methods described in the present disclosure supports parallel AI/ML model aggregation, reduces AI/ML model routing latency, and increases robustness of AI/ML model routing.

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g. in relation to FIGS. 11-15. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

What is claimed is:

1. A method, the method comprising:
receiving, from a node, information including a report related to AI/ML capability of the node;
configuring the node based on the received information, wherein configuring the node includes configuring a node type of the node, the configured node type being one of a plurality of node types, the plurality of node types comprising:
Type 1 indicative of a node configured to collect a plurality of AI/ML models and aggregate the collected AI/ML models for obtaining a first type AI/ML model, or
Type 2 indicative of a node configured to obtain a second type AI/ML model with a set of training data without aggregation operation;
configuring one or more other nodes associated with the configured node based on the configured node type;
wherein a configured topology supports AI/ML model transfer over an air interface of a wireless communication network, and includes at least one of:
a connection between at least one Type 1 node and zero or more Type 2 nodes, or
a connection between at least two Type 1 nodes.

2. The method of claim 1, wherein the configured node type indicates that the node is a Type 1 node, and the one or more other nodes include at least one of:
one or more Type 2 nodes;
a second Type 1 node providing a first type AI/ML model of the second Type 1 node to the node; or
a third Type 1 nodes receiving a first type AI/ML model of the node.

3. The method of claim 2, wherein the one or more other nodes includes the one or more Type 2 nodes, and configuring the node includes:
configuring the node to collect respective second type AI/ML models from the one or more Type 2 nodes.

4. The method of claim 1, wherein the configured node type indicates that the node is a Type 2 node, and the one or more other nodes include one or more Type 1 nodes connected to the node.

5. The method of claim 1, wherein the information further includes a request by the node to be configured as a Type 1 node.

6. A method, the method comprising:
establishing, by a first node, an aggregation connection with a second node based on an aggregation acknowledgement message;
wherein a configured topology supports AI/ML model transfer over an air interface of a wireless communication network, and includes at least one of:
a connection between at least one Type 1 node and zero or more Type 2 nodes, or
a connection between at least two Type 1 nodes;
wherein a Type 1 node is a node that is configured to collect a plurality of AI/ML models and aggregate the collected AI/ML models for obtaining a first type AI/ML model, and a Type 2 node is a node that is configured to obtain a second type AI/ML model with a set of training data without aggregation operation.

7. The method of claim 6, wherein the message for aggregation is a discovery message including aggregation information to be used by the second node for discovery of the first node.

8. The method of claim 7, wherein the discovery message includes at least one of a model collection indicator or a reference AI/ML model.

9. The method of claim 6, wherein the message for aggregation is an aggregation request message, the aggregation request message including an aggregation request or information related to a second type AI/ML model of the first node.

10. The method of claim 9, wherein the first node is a Type 2 node and the aggregation request message includes the information related to the second type AI/ML model of the first node.

11. A network device, the network device comprising:
at least one processor; and
a memory storing processor-executable instructions that, when executed, cause the at least one processor to:
receive, from a node, information including a report related to AI/ML capability of the node;
configure the node based on the received information, wherein configuring the node includes configuring a node type of the node, the configured node type being one of a plurality of node types, the plurality of node types comprising:
Type 1 indicative of a node configured to collect a plurality of AI/ML models and aggregate the collected AI/ML models for obtaining a first type AI/ML model, or
Type 2 indicative of a node configured to obtain a second type AI/ML model with a set of training data without aggregation operation;
configure one or more other nodes associated with the configured node based on the configured node type;
wherein a configured topology supports AI/ML model transfer over an air interface of a wireless communication network, and includes at least one of:
a connection between at least one Type 1 node and zero or more Type 2 nodes, or
a connection between at least two Type 1 nodes.

12. The network device of claim 11, wherein the configured node type indicates that the node is a Type 1 node, and the one or more other nodes include at least one of:
one or more Type 2 nodes;
a second Type 1 node providing a first type AI/ML model of the second Type 1 node to the node; or
a third Type 1 nodes receiving a first type AI/ML model of the node.

13. The network device of claim 12, wherein the one or more other nodes includes the one or more Type 2 nodes, and configuring the node includes:
configuring the node to collect respective second type AI/ML models from the one or more Type 2 nodes.

14. The network device of claim 11, wherein the configured node type indicates that the node is a Type 2 node, and the one or more other nodes include one or more Type 1 nodes connected to the node.

15. The network device of claim 11, wherein the information further includes a request by the node to be configured as a Type 1 node.

16. An apparatus for a node, the apparatus comprising:
at least one processor; and
a memory storing processor-executable instructions that, when executed, cause the at least one processor to:
establish, an aggregation connection with a second node based on an aggregation acknowledgement message;
wherein a configured topology supports AI/ML model transfer over an air interface of a wireless communication network, and includes at least one of:
a connection between at least one Type 1 node and zero or more Type 2 nodes, or
a connection between at least two Type 1 nodes;
wherein a Type 1 node is a node configured to collect a plurality of AI/ML models and aggregate the collected AI/ML models for obtaining a first type AI/ML model, and a Type 2 node is a node configured to obtain a second type AI/ML model with a set of training data without aggregation operation.

17. The apparatus of claim 16, wherein the message for aggregation is a discovery message including aggregation information to be used by the second node for discovery of the first node.

18. The apparatus of claim 17, wherein the discovery message includes at least one of a model collection indicator or a reference AI/ML model.

19. The apparatus of claim 16, wherein the message for aggregation is an aggregation request message, the aggregation request message including an aggregation request or information related to a second type AI/ML model of the first node.

20. The apparatus of claim 19, wherein the first node is a Type 2 node and the aggregation request message includes the information related to the second type AI/ML model of the first node.
